(19) United States
(12) Patent Application Publication
(10) Pub. No.: US 2003/0164027 A1
(43) Pub. Date: Sep. 4, 2003

(54) Method for determining surface tension of a comminuted solid

(76) Inventor: Gerard Terrom, Lyon (FR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/311,992

(22) PCT Filed: Jun. 19, 2001
(86) PCT No.: PCT/FR01/01906

(30) Foreign Application Priority Data
Jun. 20, 2000 (FR) 00/07878

(51) Int. Cl. G01N 13/00

(52) U.S. Cl. 73/64.48

(57) ABSTRACT

The invention concerns a method for determining the surface tension of a comminuted solid based on different experimental measurements and different mathematical equations. Said method uses the principle of capillary rise of a probe liquid through a tube partly filled with the comminuted solid and closed on one side with a permeable membrane. The method consists in firstly allowing the liquid to rise freely in the tube, in producing a first counter-pressure on the tube, in allowing once more the free rising system, then in applying a second counter-pressure. Throughout the process the evolution of the liquid mass having risen in the tube is measured on a time basis. And based on different mathematical equations, the surface tension γₛ of the comminuted solid is calculated.

The present invention relates to a process for determining the surface tension of a comminuted solid, so as to better define its characteristics and surface properties.

More precisely, this process uses the combination of different experimental measures with mathematical equations.

The different chemical industries that use comminuted solids (also called powders) to prepare compositions are regularly faced with problems during dispersion of the powder in a liquid, or when drying the powder which very easily tends to agglomerate, or on the contrary is difficult to separate or separates too easily after it has been compressed.

Consequently, in order to solve these disadvantages, an attempt has to be made to minimize the interface energy to improve wetting or stability of solid-liquid dispersion compositions.

Interface energy values must be known as precisely as possible, in order to optimise action on them.

Previously known processes for determining the surface tension of powder make use of the principle of successive capillary rise of different liquids in a tube partially filled by the comminuted solid for which the surface tension is to be found. Unlike liquid bodies, in this case it is impossible to proceed based on deformation of the surface. Thus, it may be difficult to measure this energy precisely.

Kinetic monitoring of the capillary rise of a liquid rising in a tube (called a probe liquid) in a porous medium to be studied (such as a powder) is one of the simplest processes to implement.

The capillary rise rate is determined by monitoring the variation with time of the mass of the tube full of powder.

Unfortunately, this type of process requires that several probe liquids are used, and that the geometric characteristics of the porous network of the powder column are known perfectly.

Furthermore, the direct transposition of experimental surface tension measurement mechanisms from a compact solid to a comminuted solid, in mathematical equations well known to an expert in the subject such as Washburn's equation, causes many problems.

The physical characteristics of the porous network of the comminuted solid must be perfectly defined so that the surface tension of this solid can subsequently be calculated correctly.

There is still a need for a process to quickly and very easily determine the surface tension γₛ of a comminuted solid based on the principle of capillary rise of a liquid in a tube full of this solid using a single probe liquid.

Therefore, the purpose of this invention is a process for determining the surface tension γₛ of a comminuted solid starting from different experimental measurements and different mathematical equations consisting of:

taking a tube, the lower end of which is hermetically sealed by a membrane permeable to the liquid,

filling it to about 80% of its total volume with the said comminuted solid,

dipping the lower part closed by the membrane in a liquid,

allowing the liquid to rise freely in a first phase in the tube,

measuring the liquid mass that rose in the tube as a function of time by monitoring the variation of the remaining mass of the liquid, in order to obtain the slope 1 of the straight line described by equation (I) below:

m²=f(t) (equation I)

characterized in that:

in a second phase, when 10 to 20% of the total height of the powder is in contact with the liquid, a first back pressure is applied to the upper part of the tube so as to stop the capillary rise of the liquid in the tube through the comminuted solid, and to measure the numeric value of the remaining liquid mass after the liquid has risen so as to determine the mass of the liquid that rose into the tube by mathematical calculation, as soon as the pair consisting of the pressure and the mass variation has stabilized, and then after using the mathematical equation:

ΔP=(A.Δγ)−(εpgh) (equation II)

to obtain the numeric value of (A.Δγ)

where

A is the specific area of the comminuted solid (m²/m³)

Δγ=γₛ−γ_{sL} is the difference between the surface tension of the solid (γₛ) and the solid-liquid interface energy (γ_{SL}),

ε is the porosity of the comminuted solid,

p is the density of the liquid (kg/m³),

g is the acceleration due to gravity (9.81),

h is the height of the comminuted solid in the tube,

ΔP is the pressure variation applied on the tube,

in a third phase, to stop applying the first back pressure so as to allow the liquid to rise freely in the tube until the comminuted solid is fully immersed in the liquid present in the tube, and to regularly measure the variation of the remaining mass of liquid after the liquid has risen in the tube, as a function of time, to afterwards deduce the total mass of liquid risen in the tube and after a mathematical calculation, and then to use a mathematical equation (I) to obtain the slope 2 and then the porosity ε according to equation (III) below:

$$ϵ = \frac{liquid volume at saturation}{powder volume in the tube} \qquad \text{(equation III)}$$

and then to use the mathematical equation (IV):

$${Q}_{exp} = \frac{{( ϵ \cdot π \cdot {R}^{2} )}^{2}}{β} \times ( A \cdot Δγ ) \qquad \text{(equation IV)}$$

where

Qₑₓₚ (kg.m/s²) is equal to [1/(2×γ_{liq})]×slope 2

where γ_{liq}=ρ/η, where η is the viscosity of the probe liquid in Pa.s,

R is the internal radius of the tube,

ε is the porosity of the comminuted solid,

the numeric value of β where β is the tortuousness coefficient,

in a fourth step, to apply a negative pressure on the top part of the tube, kept constant for a period varying from 300 to 1000 seconds, to measure the numeric value of the remaining liquid mass after the liquid has risen in the tube, and then to use a mathematical calculation to deduce the rate of variation of the liquid mass risen in the tube, and then the numeric value of the specific area A(m²/m³) of the powder in the tube, using Kozeny-Carman's equation (V) defined below:

$${A}^{2} = \frac{Δ P}{5 \cdot η \cdot h \cdot v} \times \frac{{ϵ}^{3}}{( 1 - ϵ )} \qquad \text{(equation V)}$$

where

ΔP is the pressure variation applied to the tube,

η is the viscosity of the liquid,

h is the powder height in the tube,

v is the rise velocity of the liquid,

ε is the porosity of the comminuted solid,

and to apply a second back pressure in a fifth step, on the top part of the tube and held constant for a duration of about 300 to 1000 seconds, to make another calculation of the numeric value of the specific area A (m²/m³) as defined in step 4.

The invention has the advantage that it can be used to determine the surface tension γₛ of a powder in a simple, fast, reliable and perfectly reproducible manner, using only a probe liquid.

Another purpose of the invention is to use the process as defined above to determine the surface tension of a comminuted solid used in the chemical composition of a solid-liquid dispersion of paints, inks, adhesives, resins.

Finally, the final purpose of the invention is related to use of the process defined above to determine the surface tension of a comminuted and agglomerated solid.

Washburn's mathematical equation (Equation VI) describes a parabolic variation of the mass “m” of the liquid as a function of time “t”, making use of its capillary rise in the tube according to:

m²=(2Γ₁.t) (equation VI)

where

m(g): liquid mass present in the tube,

t(s): time,

Γ₁: a parameter.

Determining a rate of capillary rise is a means of evaluating the parameter Γ₁ from the slope of the straight line m²=f(t)

Γ₁is defined by the following equation:

Γ₁=Γₛₒₗ.Γ_{liq}.Δ_{γ}

$$\begin{matrix}where {Γ}_{sol} = \frac{A \cdot {[ ϵ \cdot Π \cdot {R}^{2} ]}^{2}}{β} & \text{(equation VII)} \\ {Γ}_{liq} = \frac{{ρ}^{2}}{η} & \text{(equation VIII)}\end{matrix}$$

where A, ε, R, β, ρ, η have the same definitions as above.

Ωₑₓₚ is given by equation (IX) defined below and already mentioned:

$${Ω}_{exp} = \frac{1}{2 {ϰΓ}_{liq}} \times slope 2$$

and β is given by equation (X) given below:

$$β = \frac{{( ϵ \cdot Π \cdot {R}^{2} )}^{2}}{{Ω}_{exp}} \times ( A \cdot Δ y )$$

For a porous column, the parameters ε, A and β characterize the network formed in the comminuted solid.

The porosity value ε can easily be found experimentally. When liquid saturates the tube partially filled by powder with a height “h”, value of the tortuousness β can be determined directly by a mathematical calculation based on the increase in the weight of the tube “m”.

On the other hand, additional experimental measurements are necessary to find A (interface area per unit volume) and β (tortuousness coefficient).

These two parameters A and β are easily determined according to the process according to the invention, without needing to use several probe liquids or several mathematical operations with several unknowns.

Preferably the comminuted solid is chosen from among mineral solids that may be in the comminuted state, such as organic polymers or synthetic inorganic minerals, for example such as polytetrafluoroethylene (PTFE) or polyethylene, or from among organic polymers or natural minerals such as talc, glass, flour from various cereals or bacterial surfaces.

The liquid may also be chosen from among alkanes such as pentane, hexane, heptane, octane, nonane, decane, cyclohexane, hexadecane, cis-decaline, α-bromonaphthalene, diiodomethane, or among other organic compounds such as methanol, ethanol, methylethylcetone, tetrahydrofurane (THF), glycol ethylene, glycerol, formamide, dimethyl sulfoxide, water.

Preferably, the liquid may have an average density of between 0.6 and 3.5 and an average viscosity of between 0.1 and 1000 mPa.s.

The first back pressure applied during the second step may be between 5 and 800 mbars.

The negative pressure applied in the fourth step may be between 5 and 200 mbars.

The second back pressure applied during the fifth step may be between 5 and 200 mbars.

Preferably, the first and second steps may be repeated 3 or 4 times when the liquid rise is less than or equal to 10 mm.

The permeable membrane used is preferably chosen from among cellulose membranes conventionally made of cellulose acetate or cellulose nitrate with cut-off thresholds of the order of 1 to 10 μm, or from among membranes composed of glass microfibres with similar cut-off thresholds.

The negative pressure in the fourth step and the second back pressure in the fifth step are preferably applied for durations of between 60 to 600 seconds respectively.

The invention will now be described with reference to the attached figures that in no way limit the purpose of the invention.

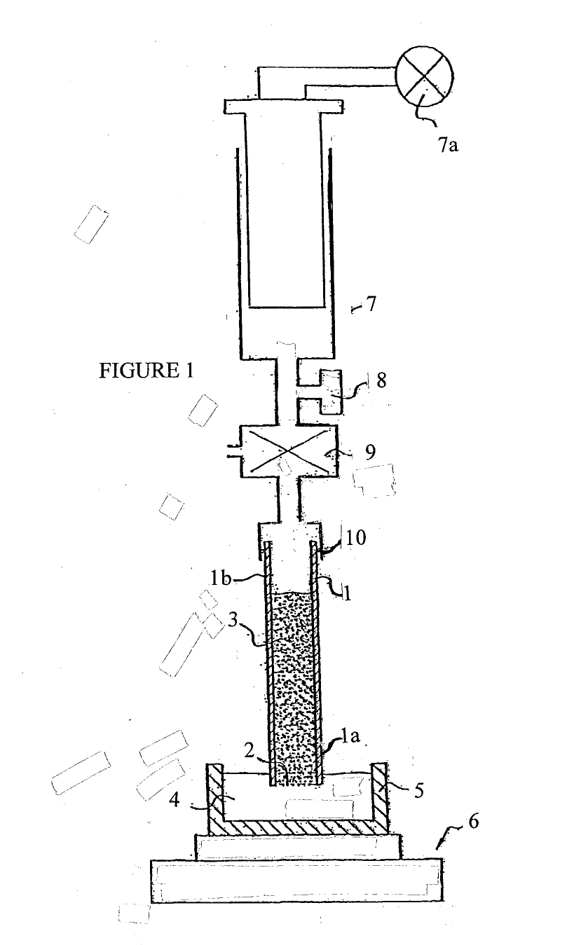

FIG. 1 is a sectional diagrammatic view of the different elements forming the equipment that will make experimental measurements during use of the process according to the invention,

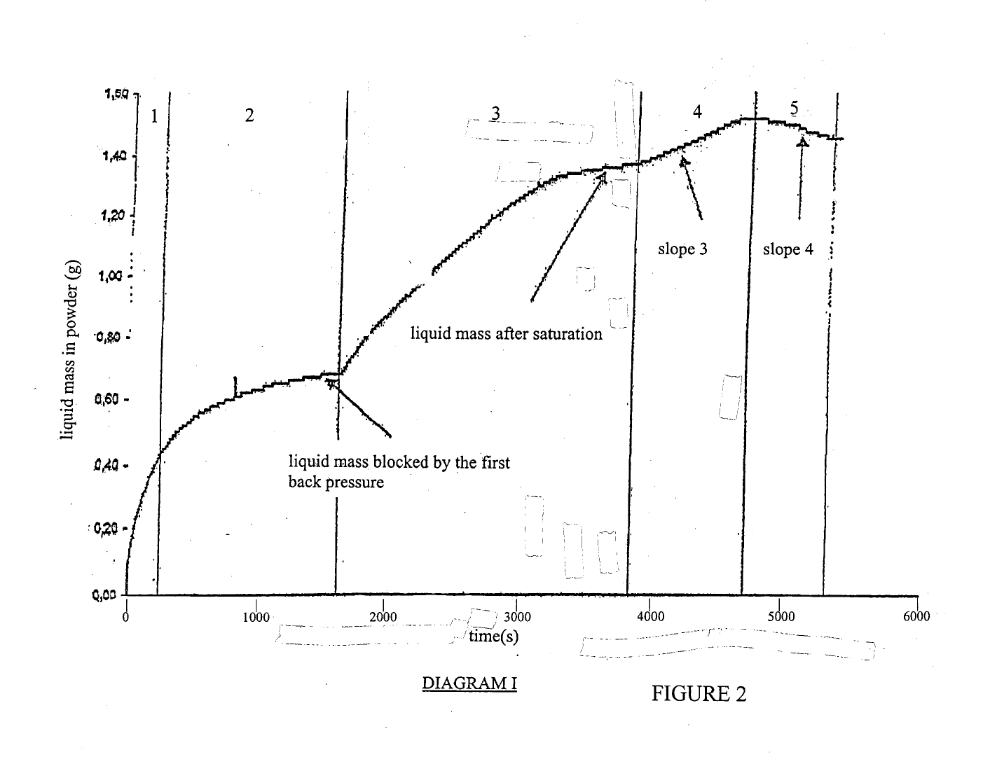

FIG. 2 shows the m=f(t) curve obtained with the five steps of the process according to example 1,

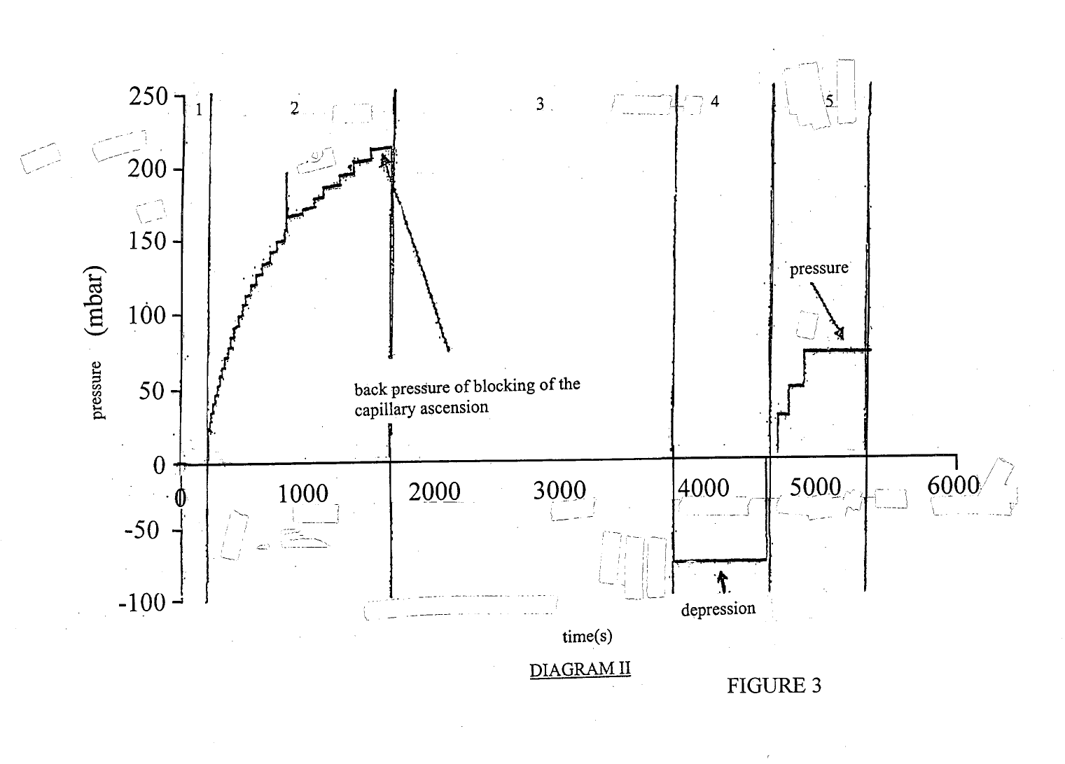

FIG. 3 shows the different applications of the back pressure and negative pressure during the process in example 1,

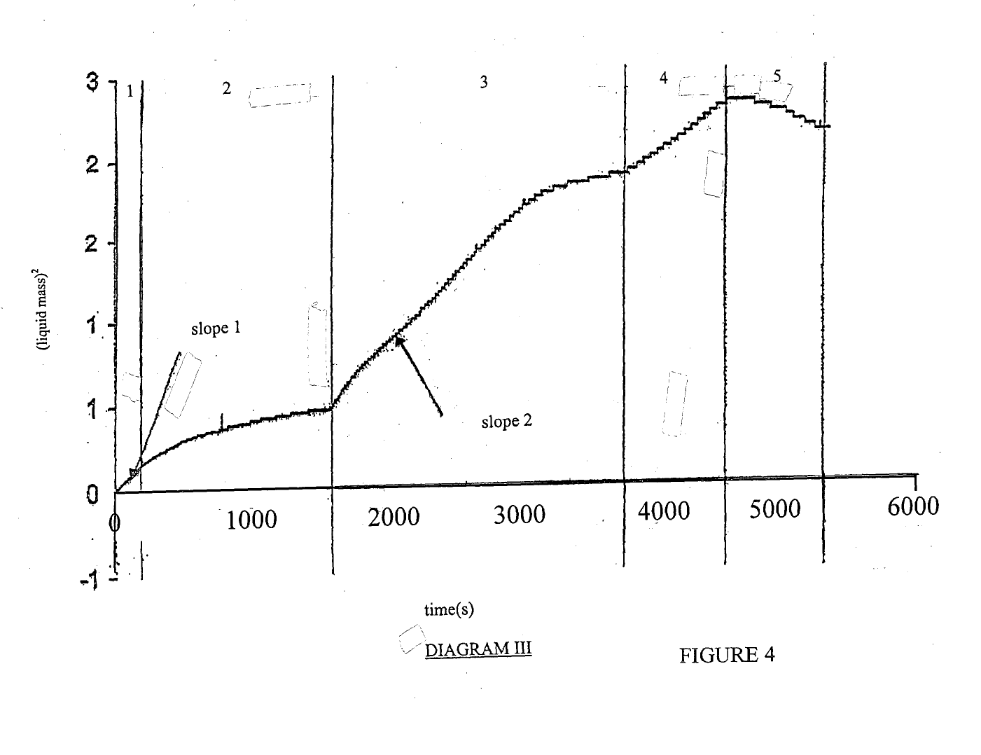

FIG. 4 shows the m²=f(t) curve necessary to obtain the value of the different slopes according to example 1.

As can be seen in FIG. 1, a glass tube reference 1 with an inside diameter of 8 mm, a cross section of 5.026×10⁻⁵ m² and a total height varying from 30 to 120 mm is hermetically sealed at its lower end 1a by a membrane 2 that is permeable to liquid and consists of a paper filter.

The tube 1 is then filled to about 80% of its total height by a comminuted solid 3, for example such as polytetrafluoroethylene (PTFE) or polyethylene.

The solid may also be composed of any mineral or organic type of chemical compounds that can be put in the powder state and that is not soluble in the probe liquid. The solid is mechanically compacted very thoroughly in the tube.

The lower part 1a of the tube 1 is then immersed in a liquid 4 placed in a dish 5. For example, the liquid 4 may be hexane and have a density ρ equal to 660 kg/m² and a viscosity η of 3×10⁻⁴ Pa.s.

The dish 5 is supported directly on the balance 6 with a precision of up to 1/100 to 1/1000 g.

The balance 6 is also connected to a computer data processing system (not shown).

During the first step, the liquid 4 rises freely by capillarity into tube 1 in a known manner through the permeable membrane 2 and the powder 3 until it reaches 10 to 20% of the height of the powder, so as to leave a portion of the powder not impregnated by the liquid 4.

Throughout the process according to the invention, the variation of the mass “m” of liquid 4 that rose in tube 1 is measured as a function of the time “t”. According to the mathematical equation m=f(t), the value of m is obtained by indirect weighing, since only the liquid remaining in the dish 5 is weighed.

The slope 1 of the curve (m₁)²=f(t₁) is calculated at the end of this first step.

Then, the mathematical equation:

$${Ω}_{exp1} = \frac{1}{2 {ϰΓ}_{liq}} \times slope 1 \\ where \\ {Γ}_{liq} = \frac{{ρ}^{2}}{η} \qquad \text{(equation IX)}$$

is used to calculate the value of Ωₑₓₚ₁.

When the height of the liquid 4 has reached 20% of the total powder height, a second step is applied in which a first vertical back pressure P₁ is applied downwards using a syringe 7. The syringe 7 is filled with a gas, usually dry air or any other inert gas that is inert to the liquid and to the solid, for example such as nitrogen, carbon dioxide or helium. The syringe 7 pushes the liquid 4 that has partially raised in tube 1 uniformly and in a controlled manner. The syringe 7 applies an isostatic pressure P₁ due to the direct pressure of the “pusher” gas acting on the probe liquid 4. The syringe 7 is activated using a mobile actuator 7a. The syringe 7 is connected to the tube 1 through a pressure sensor 8, itself connected to a solenoid valve 9 for restoring atmospheric pressure, and is connected to a joint 10 directly on the top part of the tube 1b.

When the system has reached a steady state, the back pressure P₁ is equal to 209 mbars and the height of the liquid 4 in the tube is equal to 30.9 mm.

Knowing the height of the liquid, the value εpgh of the mathematical equation (II) can be determined by calculation:

ΔP=(A.Δγ)−(εpgh)

Finally, also knowing the variation of the pressure ΔP, the value of (A.Δγ) can be calculated.

During the third step, the back pressure P1 is no longer applied so as to allow the liquid 4 to once more rise freely into tube 1, this time until the entire solid is immersed in fluid 4.

The continuous measurement of the variation of mass of liquid 4 in the tube as a function of time gives the numeric value of this mass “m” at saturation, namely 0.9 grams.

The value of slope 2 is obtained by mathematical calculation.

The mathematical equation (IV) mentioned above is applied again to obtain the value Ωₑₓₚ₂, the value of the porosity ε and therefore the value of β (tortuousness coefficient).

A negative pressure P₂=7404 Pa is then applied in a fourth step, through the syringe 7. This negative pressure is kept constant for 500 seconds.

The variation in the mass of liquid 4 as a function of time is measured continuously.

At the end of the fourth step, and after a mathematical calculation, the value of this specific area is obtained using Kozeny-Carman's formula:

$${A}^{2} = \frac{Δ P}{5 \cdot η \cdot h \cdot v} \times \frac{{ϵ}^{3}}{{( 1 - ϵ )}^{2}} \qquad \text{(equation V)}$$

Finally, during the fifth step, a second back pressure P3=7590 Pa is applied again and kept constant for 500 seconds, so that the values of the variation of the mass of liquid 4 as a function of time can be recorded correctly, and the specific area A defined in step 4 can be calculated again.

The experimental results obtained in the detailed description given above are summarized below.

### EXAMPLE 1

Liquid: hexane

Powder: PTFE

Liquid density: ρ=660 kg/m³

Liquid viscosity: η=3×10⁻⁴ Pa.s

Tube height: 67 mm

Powder weight: 3.97 grams

Tube inside diameter: 8 mm

Tube surface area: 5.0265×10⁻⁵ m²

Powder volume: 3.367×10⁻⁶ m³

| | |
|---|---|
| Phase 1 | |
| Measurement | slope 1 = 7.853 × 10⁻⁴ |
| Calculation | Ωₑₓₚ₁ = 2.7041 10⁻¹³ kg · m/s² |
| Phase 2 | |
| Measurement | liquid mass blocked by the first |
| | back pressure: 0.59 g |
| | back pressure: 209 mbars |
| Calculation | liquid height: 30.9 mm |
| | (A.Δγ) = 20954 |
| Phase 3 | |
| Measurement | liquid mass after saturation: |
| | 0.9 g |
| | slope 2: 8.24 × 10⁻⁴ |
| Calculation | ${Ω}_{exp2} = \frac{1}{2 \times {Γ}_{liq}} \times slope 2$ |
| Namely | $\begin{matrix}{Ω}_{exp2} = \frac{η}{2 {ρ}^{2}} \times slope 2 \\ = 2.8393 \times {10}^{- 13} kg \cdot m / {s}^{2}\end{matrix}$ |
| | ε = 0.405 |
| Phase 4 | |
| Measurement | slope 3: 5.63 × 10⁻⁷ kg/s |
| | negative pressure: −7404 Pa |
| Calculation | flow: 8.5389 × 10⁻¹⁰ m³/s |
| velocity: | 1.6988 × 10⁻⁵ m/s |
| | A = 916770 m²/m³ |
| Phase 5 | |
| Measurement | slope 4: 3.63 × 10⁻⁷ kg/s |
| | pressure: 7590 Pa |
| Calculation | flow: 5.50 × 10⁻¹⁰ m³/s |
| | velocity: 1.090 × 10⁻⁵ m/s |
| | A = 1131291 m²/m³ |
| Final results | |
| β = | 31315797 |
| average Γₛₒₗ = | 1.3545 × 10⁻¹¹ |
| average Δγ = | 2.0689 × 10⁻² mJ/m² |
| average γₛ = | 20.8 mJ/m² |

### EXAMPLE 2

Liquid: hexane

Powder: polyethylene

Liquid density: ρ=660 kg/m³

liquid viscosity: η=3.10⁻⁴ Pa.s

Tube height: h=69 mm

Powder weight: 1.64 grams

Tube inside diameter: 8 mm

Powder volume: 3.468×10⁻⁶ m³

| | |
|---|---|
| Phase 1 | |
| Measurement | slope 1 = 3.01 × 10⁻² |
| Calculation | Ωₑₓₚ₁ = 1.036 10⁻¹² kg.m/s² |
| Phase 2 | |
| Measurement | liquid mass blocked by the first |
| | back pressure: 0.32 g |
| | back pressure: 7.45 mbars |
| Calculation | liquid height: 19.5 mm |
| | (A.Δγ) = 808 |
| Phase 3 | |
| Measurement | liquid mass after saturation: |
| | 1.13 g |
| | slope 2: 3.30 × 10⁻³ |
| Calculation | Ωₑₓₚ₂ = 1.136 × 10⁻¹² kg.m/s² |
| | ε = 0.495 |
| Phase 4 | |
| Measurement | slope 3: 2.4 × 10⁻⁴ kg/s |
| | negative pressure: 1075 Pa |
| Calculation | flow: 3.64 × 10⁻⁷ m³/s |
| | velocity: 0.0723 m/s |
| | A = 26293 m²/m³ |
| Phase 5 | |
| Measurement | slope 4: 2.4 × 10⁻⁴ kg/s |
| | pressure: 1014 Pa |
| Calculation | flow: 3.64 × 10⁻⁷ m³/s |
| | velocity: 0.0723 m²/s |
| | A = 25440 m²/m³ |
| Final results | |
| β | = 461409 |
| average Γₛₒₗ | = 3.47 × 10⁻¹¹ |
| average Δγ | = 3.13 × 10⁻² mJ/m² |
| average γₛ | = 33.6 mJ/m² |

1. Process for determining the numeric value of the surface tension γ of a comminuted solid starting from different experimental measurements and different mathematical equations consisting of:
taking a tube, the lower end of which is hermetically sealed by a membrane permeable to the liquid,
filling it to about 80% of its total volume with the said comminuted solid,
dipping the lower part closed by the membrane in a liquid,
allowing the liquid to rise freely in a first phase in the tube,
measuring the liquid mass that rose in the tube as a function of time by monitoring the variation of the remaining mass of the liquid, in order to obtain the slope 1 of the straight line described by equation (I) below:
m²=f(t) (equation I)
characterized in that:
in a second phase, when 10 to 20% of the total height of the powder is in contact with the liquid, a first back pressure is applied to the upper part of the tube so as to stop the capillary rise of the liquid in the tube through the comminuted solid, and to measure the numeric value of the remaining liquid mass after the liquid has risen so as to determine the mass of the liquid that rose into the tube by mathematical calculation, as soon as the pair consisting of the pressure and the mass variation has stabilized, and then after using the mathematical equation:
ΔP=(A−Δγ)−(εpgh) (equation II)
to obtain the numeric value of (A−Δγ)
where
A is the specific area of the comminuted solid (m²/m³)
Δγ=γₛ−γ_{sL} is the difference between the surface tension of the solid (Yₛ) and the solid-liquid interface energy (Y_{SL}),
ε is the porosity of the solid,
p is the density of the liquid,
g is the acceleration due to gravity (9.81),
h is the height of the comminuted solid in the tube,
ΔP is the pressure variation applied on the tube,
in a third phase, to stop applying the first back pressure so as to allow the liquid to rise freely in the tube until the comminuted solid is fully immersed in the liquid present in the tube, and to regularly measure the variation of the remaining mass of liquid after the liquid has risen in the tube, as a function of time, to afterwards deduce the total mass of liquid risen in the tube and after a mathematical calculation, and then to make a mathematical equation (I) to obtain the slope 2 and then the porosity ε according to equation (III) below:
$$ϵ = \frac{liquid volume at saturation}{powder volume in the tube} \qquad \text{(equation III)}$$
and then to use the mathematical equation (IV):
$${Q}_{exp} = \frac{{( ϵ \cdot π \cdot {R}^{2} )}^{2}}{β} \times ( A \cdot Δγ ) \qquad \text{(equation IV)}$$
where
Qₑₓₚ (kg.m/s²) is equal to [1/(2×Γ_{liq})]×slope 2
where Γ_{liq}=ρ/η, where η is the viscosity of the probe liquid in Pa.s,
R is the internal radius of the tube,
ε is the porosity of the comminuted solid,
the numeric value of β where β is the tortuousness coefficient,
in a fourth step, to apply a negative pressure on the top part of the tube, kept constant for a period varying from 300 to 1000 seconds, to measure the numeric value of the remaining liquid mass after the liquid has risen in the tube, and then to use a mathematical calculation to deduce the rate of variation of the liquid mass risen in the tube, and then the numeric value of the specific area A(m²/m³) of the powder in the tube, using Kozeny-Carman's equation (V) defined below:
$${A}^{2} = \frac{Δ P}{5 \cdot η \cdot h \cdot v} \times \frac{{ϵ}^{3}}{( 1 - ϵ )} \qquad ( equation V )$$
where
ΔP is the pressure variation applied to the tube,
η is the viscosity of the liquid,
h is the powder height in the tube,
v is the rise velocity of the liquid,
ε is the porosity of the comminuted solid,
and to apply a second back pressure in a fifth step, on the top part of the tube and held constant for a duration of about 300 to 1000 seconds, to make another calculation of the numeric value of the specific area A (m²/m³) as defined in step 4.

2. Process according to claim 1, characterized in that the comminuted solid is chosen from among organic polymers or synthetic inorganic minerals, for example such as polytetrafluoroethylene (PTFE) or polyethylene, or from among organic polymers or natural minerals such as talc, glass, flour from various cereals or bacterial surfaces.

3. Process according to claim 1, characterized in that the liquid is chosen from among alkanes such as pentane, hexane, heptane, octane, nonane, decane, cyclohexane, hexadecane, cis-decaline, α-bromonaphthalene, diiodomethane, or among other organic compounds such as methanol, ethanol, methylethylcetone, tetrahydrofurane (THF), glycol ethylene, glycerol, formamide, dimethyl sulfoxide, water.

4. Process according to one of claims 1 to 3, characterized in that the average density of the liquid is between 0.6 and 3.5 and its average viscosity is between 0.1 and 1000 mPa.s.

5. Process according to claim 1, characterized in that the first back pressure applied during the second step may be between 5 and 800 mbars.

6. Process according to claim 1, characterized in that the negative pressure applied in the fourth step may be between 5 and 200 mbars.

7. Process according to claim 1, characterized in that the second back pressure applied during the fifth step may be between 5 and 200 mbars.

8. Process according to claim 1, characterized in that the first and second steps may be repeated 3 or 4 times when the liquid rise is less than or equal to 10 mm.

9. Process according to claim 1, characterized in that the permeable membrane used is chosen from among cellulose membranes conventionally made of cellulose acetate or cellulose nitrate with cut-off thresholds of the order of 1 to 10 μm, or from among membranes composed of glass microfibres with similar cut-off thresholds.

10. Process according to claim 1, characterized in that the negative pressure in the fourth step and the second back pressure in the fifth step are preferably applied for durations of between 60 to 600 seconds respectively.

11. Use of the process as defined in any one of the previous claims to determine the surface tension of the comminuted solid used in the chemical composition of a solid-liquid dispersion of paints, inks, adhesives, resins.

12. Use of the process as defined according to any one of claims 1 to 10, to determine the surface tension of the comminuted, agglomerated solid.
